(19) United States
(12) Patent Application Publication
(10) Pub. No.: US 2021/0072944 A1
(43) Pub. Date: Mar. 11, 2021

(54) ANIMATIONS OVER MULTIPLE SCREENS IN AN IN-FLIGHT ENTERTAINMENT SYSTEM

(71) Applicant: Panasonic Avionics Corporation, Lake Forest, CA (US)

(72) Inventors: Jonas Neldeborn, Skurup (SE); Robin Butler, Malmo (SE); Michael Wells, Malmo (SE); Daniel Anttila, Staffanstorp (SE)

(21) Appl. No.: 16/561,784

(22) Filed: Sep. 5, 2019

(51) Int. Cl. G06F 3/14; H04N 21/214; H04N 21/482; H04N 21/478; H04N 21/414; B64D 11/00

(52) U.S. Cl. CPC G06F 3/1446; H04N 21/2146; B64D 11/00151; H04N 21/4781; H04N 21/41422; H04N 21/482

(57) ABSTRACT

An expansion of the display of graphical content over multiple spatially separated smart monitors of an in-flight entertainment system involves initiating data communications links between each of the multiple smart monitors. A background graphical content is segmented into corresponding sections for each of the multiple smart monitors, with being unique to a specific one. Each of the sections of the background graphical content are displayed on the respective smart monitors, and a moving foreground graphical content is animated across one or more of the smart monitors. Transitions of the moving foreground graphical content from an originating one of the smart monitors to a destination one of the smart monitors is communicated over the corresponding data communications link initiated therewith. Inputs from the smart monitors are received to correspondingly modify the animating of the moving foreground graphical content.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to vehicle-installed entertainment systems, and those onboard aircraft in particular that are referred to as in-flight entertainment and communications (IFEC) systems. More specifically, the present disclosure relates to presenting various content and animations across multiple displays of IFEC systems.

### 2. Related Art

Air travel typically involves journeys over extended distances that at the very least take several hours to complete, so airlines provide onboard in-flight entertainment and communications systems that offer a wide variety of multimedia content for passenger enjoyment. Recently released movies are a popular viewing choice, as are television shows such as news programs, situation and stand-up comedies, documentaries, and so on. Useful information about the destination such as airport disembarking procedures, immigration and custom procedures and the like are also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger.

The specific installation may vary depending on service class, though in general, each passenger seat is equipped with a display device, an audio output modality, an input modality, and a terminal unit. The terminal unit may generate video and audio signals, receive inputs from the input modality, and execute pre-programmed instructions in response thereto. The display device is typically a liquid crystal display (LCD) screen that is installed on the seatback of the row in front of the passenger, though in some cases it may be mounted to a bulkhead or retractable arm, or the like, that is in turn mounted to the passenger's seat. Furthermore, the audio output modality is a headphone jack, to which a headphone, either supplied by the airline or by the passenger, may be connected. Inputs to the terminal unit may be provided via a separate multi-function remote controller or by via a combination touch display. Although the terminal unit and the display device were separate components in earlier IFEC implementations, more recently, these components and more may be integrated into a single smart monitor.

The multimedia content is encoded and stored as digital data on an on-board IFEC head-end server. The smart monitor and the head-end server thus incorporate networking modalities such as hubs and switches to establish data communications between each other. Furthermore, the smart monitor may be loaded with and execute a menu software application that allows the user to navigate through the available selection of multimedia content, as well as the aforementioned game, mapping, and other informational software applications. Once a selection of multimedia content for playback is made by the passenger, the smart monitor retrieves the corresponding data, and a video decoder and an audio decoder function to generate the video and audio signals to the display device and the audio output modality, respectively, for presentation to the passenger.

In earlier implementations of IFEC systems, full interactivity with the seatback units was typically disabled until some point after the initial climb (ICL) phase of the flight when the aircraft had completed takeoff and safely cleared the runway. With the exception of presenting safety briefings and making other public announcements, the display device was blanked, and the terminal unit did not accept any user inputs. More recently, however, all features of the smart monitor may be immediately available from the moment the passenger is seated while the aircraft is still at the terminal. Accordingly, the passenger can start using the IFEC system while waiting for other passengers to continue boarding. Unless specifically activated by the passenger, the display device typically remains blanked, especially during flight when the display backlight may be disruptive to sleep or other activities. Depending on the preference of the airline, it is possible for a static image (such as the airline company logo), or a looping video/animation sequence to be displayed during the standing, pushback/towing and taxiing phases of the flight even without the passenger activating or otherwise engaging with the smart monitor.

Whether the display of such uniform content is dictated to the smart monitor, or the graphical user interface of the various passenger-facing applications and the selected multimedia content is displayed on the smart monitor in response to individual passenger input, it is understood to be to a single display device. That is, for example, the same static logo screen may be shown on each of the display devices, and the graphical user interfaces of the applications and the presentation of multimedia content is limited to one screen for the single passenger. Accordingly, there is a need in the art for IFEC display outputs to span multiple display devices across a single row of seats, or along multiple rows of seats in an aisle to enhance the passenger experience while using the IFEC system. There is also a need in the art for presenting animations and other rich multimedia content with elements that move from one display device to another, as well as static images spanning multiple display devices for maximum impact to keep the attention of the passenger on the airline company identity during all phases of flight, including boarding and disembarking.

### BRIEF SUMMARY

brief description The present disclosure is directed to the display of images and animation on in-flight entertainment systems over multiple display screens, each of the display s communicating with each other across rows and aisles of seats. In one exemplary implementation a bird or other visual element may be animated to traverse the display screens. In another exemplary implementation, an interactive table tennis/ping pong game may generate a ball that is bounced between movable paddles positioned within each of the display screens. Movie content may also be displayed across multiple screens for a shared viewing experience.

One embodiment of the disclosure is a method for expanding the display of graphical content over multiple spatially separated smart monitors of an in-flight entertainment system. The method may include initiating data communications links between each of the multiple smart monitors. Additionally, there may be a step of segmenting a background graphical content into corresponding sections for each of the multiple smart monitors. Each of the sections may be unique to a specific one of the smart monitors. The method may include displaying each of the sections of the background graphical content on respective ones of the smart monitors, followed by a step of animating a moving foreground graphical content across one or more of the smart monitors. Transitions of the moving foreground graphical content from an originating one of the smart monitors to a destination one of the smart monitors may be communicated over the corresponding data communications link initiated therewith. There may also be a step of receiving inputs from the smart monitors. The inputs may correspondingly modify the animating of the moving foreground graphical content.

Another embodiment may be a vehicle-installed entertainment system with interconnected display units each including a data processor, an output display, and a network interface. Each display unit may correspond to individual passenger seats. The system may include a linked display output generator executed by a data processor of a first display unit. A composite output display screen including background visual content elements and one or more foreground visual content elements may be rendered by the first linked display output generator based upon an output from an application. The system may further include a display linking server executed by the data processor of the first display unit. Additionally, there may be a display segmenter dividing the composite output display screen into a plurality of display screen segments. A designated local display screen segment may be passed to a first local graphic output. One or more secondary display screen segments may be passed to the first display linking server. The system may also include a display linking client being executed by the data processor of a second display unit. The display linking client may also be in communication with the display linking server to receive one of the one or more secondary display screen segments passed to a second local graphic output of the second display unit.

Yet another embodiment of the present disclosure contemplates a method for presenting content on multiple display devices of an in-flight entertainment system. The method may include establishing a data communications link between a first one of the multiple display devices and a second one of the multiple display devices. The first one of the multiple display devices may be defined by a first display proximal end and an opposite first display distal end. The second one of the multiple display devices may be defined by a second display proximal end adjacent to the first display distal end and an opposite second display distal end. The method may include a step of initiating a display of a first background segment of the content on the first one of the multiple display devices, along with a display of a second background segment of the content on the second one of the multiple display devices. There may be a step of animating one or more foreground visual elements on the first one of the multiple display devices. The one or more foreground visual elements may have general trajectories along a direction of the first display proximal end toward the first display distal end. Successive sections of individual ones of the one or more visual elements may be removed from the first one of the multiple display devices as each of the sections move toward and reach the first display distal end. The method may also include transmitting transition instructions to the second one of the multiple devices from the first one of the multiple display devices upon successive sections of the individual ones of the one or more foreground visual elements reach the first display distal end. The method may proceed to a step of animating corresponding sections of the one or more foreground visual elements that are being animated off of the first one of the multiple display devices. This may be in response to the transition instructions. The one or more foreground visual elements may have general trajectories along a direction of the second display proximal end toward the second display distal end.

The present disclosure will be best understood by reference to the following detailed description when read in conjunction with the accompanying drawings.

### OF THE DRAWINGS

These and other features and advantages of the various embodiments disclosed herein will be better understood with respect to the following description and drawings, in which like numbers refer to like parts throughout, and in which:

FIG. 1 is a diagram of an exemplary aircraft environment in which one aspect of the presently disclosed system for presenting content across multiple display devices;

FIG. 2 is a block diagram illustrating the hardware components of smart monitors utilized in various embodiments of the present disclosure;

FIG. 3 is a rear perspective view of an example arrangement of seats with interconnected smart monitors of an IFEC system;

FIG. 4 illustrates a multi-display configuration according to an embodiment;

FIG. 5 is a flowchart of one exemplary embodiment for presenting content on multiple display devices;

FIGS. 6A, 6B, and 6C are screen captures showing an animation sequence of a greeting presentation in which a foreground visual element moves from one screen to the next;

FIGS. 7A, 7B, and 7C are screen captures showing an animation sequence of a flight introduction presentation highlighting the origin and destination of the flight, together with respective identifiers, temperatures, and local time;

FIGS. 8A and 8B are screen captures showing a display sequence of a multimedia content introduction presentation;

FIG. 9 is a screen capture of multiple displays with a single multimedia content being presented across the same;

FIGS. 10A, 10B, 10C, and 10D are screen captures of an example multiplayer game interface in accordance with an embodiment of the present disclosure; and

FIG. 11 is a block diagram illustrating the components of an exemplary vehicle-installed entertainment system with interconnected display units.

### DETAILED DESCRIPTION

The present disclosure is directed to systems and methods for presenting animation and other content across multiple display devices of a vehicle entertainment system. The detailed description set forth below in connection with the appended drawings is intended as a description of the presently preferred embodiments of the system and is not intended to represent the only form in which it can be developed or utilized. The description sets forth the features of the system in connection with the illustrated embodiments. It is to be understood, however, that the same or equivalent functions may be accomplished by different embodiments that are also intended to be encompassed with the present disclosure. It is further understood that the use of relational terms such as first, second, distal, proximal, and the like are used solely to distinguish one from another entity without necessarily requiring or implying any actual such order, priority, or relationship between such entities.

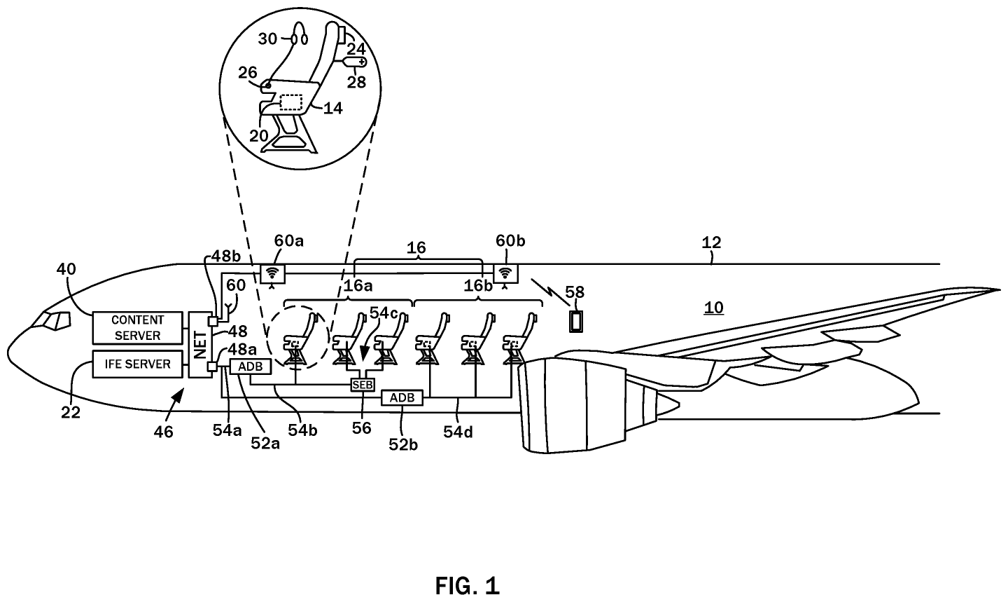

FIG. 1 is a simplified diagram of an aircraft 10, generally referred to herein as a vehicle, along with select subsystems and components thereof. Within a fuselage 12 of the aircraft 10, there may be seats 14 arranged over multiple rows 16, with each seat 14 accommodating a single passenger. Although the features of the present disclosure will be described in the context of the aircraft 10, this is by way of example only and not of limitation. The presently disclosed embodiments of the user interface co-development environment may be applicable to other contexts as appropriate, such as, by way of non-limiting illustrative example, busses, trains, ships, and other types of vehicles.

Installed in the aircraft 10 is an in-flight entertainment and communications (IFEC) system 18, through which various entertainment and connectivity services may be provided to passengers while onboard. When referenced generally, the IFEC system 18 is understood to encompass terminal devices 20 installed for each seat 14, as well as the IFEC server 22 and the other components involved in the delivery of the entertainment and communications functionality. In the illustrated example, this includes a display 24, an audio output 26, and a handset or remote controller 28. For a given row 16 of seats 14, the terminal device 20 and the audio output 26 are disposed on the seat 14 for which it is provided, but the display 24 and the remote controller 28 may be located on the row 16 in front of the seat 14 to which it is provided. That is, the display 24 and the remote controller 28 are installed on the seatback of the row in front of the seat. Other display 24 and remote controller 28 mounting and access configurations such as a retractable arm or the like mounted to an armrest of the seat 14 or by mounting on a bulkhead are also possible.

The display 24 is understood to be a conventional liquid crystal display (LCD) screen or other type with a low profile that is suitable for installation on the seatback. Each passenger can utilize an individual headset 30, supplied by either the airline or by the passenger, which provides a more private listening experience. The audio output 26 may be a headphone jack that is a standard ring/tip/sleeve socket. The headphone jack may be disposed in proximity to the display 24 or on the armrest of the seat 14 as shown. The headphone jack may be an active type with noise canceling and including two or three sockets or a standard audio output without noise canceling. Each display 24 may incorporate the aforementioned terminal device 20 to form a unit referred to in the art as a smart monitor.

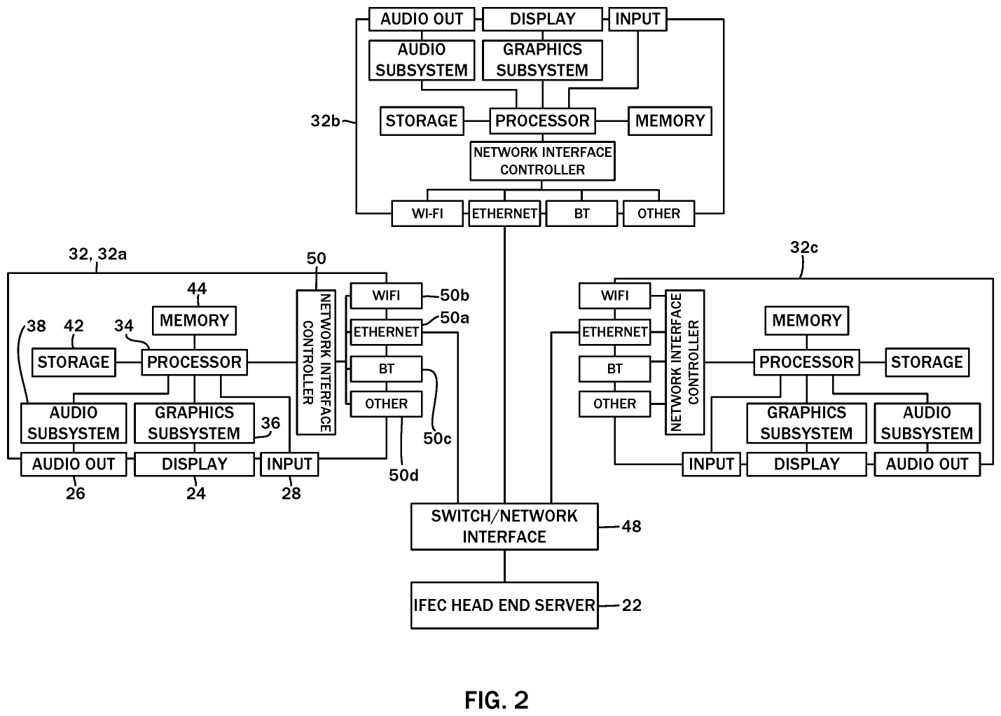

A common use for the terminal device 20 or smart monitor installed on the aircraft 10 is the playback of various multimedia content. With additional reference to the block diagram of FIG. 2, a smart monitor 32 may be implemented with a general-purpose data processor 34 that decodes the data files corresponding to the multimedia content and generates video and audio signals for the display 24 and the audio output 26, respectively.

The display 24 may be connected to a graphics subsystem 36 that generates a continuous feed of image data corresponding to the images that are to be presented on the display 24. The graphics subsystem 36 is connected to the data processor 34 that is the source of the display output, but the display output rendering of such images may be handled by an on-board graphics processing unit. In addition to the physical connection interfaces to the display 24 and the graphics processing unit, the graphics subsystem 36 may also include a video memory from which the video data is transferred to the display 24 digitally over a DVI, HDMI, or a DisplayPort interface.

Along the same lines, the audio output 26 may be connected to an audio subsystem 38 that generates the analog audio electrical signals corresponding to the sound that is output from the headset 30. In this regard, the audio subsystem 38 may include a digital-to-analog converter that receives the digital data for the audio stream from the data processor 34, and converts the same to the analog audio signal. Additionally, the audio subsystem may include various amplifiers, noise filters, active noise cancelling circuits, and so forth.

With concurrent reference back to FIG. 1, the multimedia content data files may be stored in one or more content servers 40, and streamed to specific smart monitors 32 upon request. The content may be encrypted, so the digital rights management functionality to enable streaming/playback may be performed by the IFEC server 22. Functionality not pertaining to the delivery of multimedia content, such as relaying imagery from external aircraft cameras, flight path/mapping information, and the like may also be performed by the IFEC server 22. Each of the smart monitors 32 may be provided with a data storage device 42 to which such streamed multimedia content may be saved, among other data and software applications. The data storage device 42 may be a mechanical hard disk drive, or more preferably, a solid state drive (SSD) that is understood to be particularly advantageous in aircraft installations for its reduced footprint and weight.

The passenger can play games being executed on the smart monitor 32 and otherwise interact with the multimedia content with the remote controller 28. As shown in the block diagram of FIG. 2, the remote controller 28 serves as an input modality that is connected to the data processor 34, which utilizes the provided input to modify the execution of application software being processes thereby. These software applications may be loaded into a memory 44 during execution, and stored on the local data storage device 42 instead of retrieving the same from the IFEC server 22 in response to each invocation or request.

Navigating through the vast multimedia content library and selecting ones for viewing and/or listening is also possible with the remote controller 28, though in some different installations, a touch-screen display may be provided for a more intuitive interaction with the multimedia content library. In either case, the smart monitor 32 is loaded with a content selection software application that is executed by the data processor 34 and accepts input from the remote controller 28 or other input modality and generates a response on a graphical interface presented on the display 24.

Each of the smart monitors 32 for the seats 14 may be connected to the IFEC server 22, the content server 40, or any other server that is part of the IFEC system 18 over a local area network 46, one segment of which may preferably be Ethernet. The IFEC system 18 thus includes a data communications module 48, and more specifically, an Ethernet data communications module 48a, e.g., an Ethernet switch or router. In a typical aircraft installation, the data communications module 48 is understood to be a separate line replaceable unit (LRU), and may also be referred to as a network controller (NC) Likewise, the IFEC server 22, the content server 40, and the other servers onboard the aircraft 10 are understood be standalone computer systems with one or more general purpose data processors, memory, secondary storage, and a network interface device for connecting to the local area network 46. The computer systems may have an operating system installed thereon, along with server applications (e.g., web servers, streaming servers, and so forth) providing various in-flight entertainment/communications services in cooperation with the smart monitors 32 connected thereto.

In order to connect to the local area network 46, the smart monitors 32 each include a network interface controller 50. Like the data communications module 48 at the server head end, the network interface controller 50 may include an Ethernet data communications module 50a, e.g., a Ethernet card. The network interface controller 50 is understood to direct incoming traffic from the local area network 46 to the data processor 34, and outgoing network traffic destined for a remote node as provided by the data processor 34. As will be described below, wireless local area networking modalities may be utilized, in which case the network interface controller 50 may include a WiFi module 50b. Additionally, personal area networks based on Bluetooth may be used to connect to, for example, the headset 30, so there may be a Bluetooth module 50c. Furthermore, interfaces 50d for other wired peripheral connections such as USB may be provided, with the network interface controller 50 serving as the gateway. In the context of the presently disclosed embodiments of the smart monitor 32, the Ethernet data communications module 50a, the WiFi module 50b, the Bluetooth module 50c, and understood to refer to data communications interfaces with suitable transmitter and receiver circuit hardware, a controller integrated circuit with specific software thereon configured to implement the respective datagram segmenting and other transmission/reception functions defined by the communications standards thereof, among others.

The local area network 46 may be logically separated into tiered segments, with the network controller/data communications module 48 being at the top of the hierarchy or central to all of the segments. The smart monitors 32 may be organized according to sections, rows, or columns of seats 14, and the local area network 46 may be structured accordingly. There may be a first area distribution box (ADB) 52, which may also be a line replaceable unit that is directly connected to the network controller/data communications module 48 and establishes a segment of the local area network 46 for a first set of rows 16a. Connected to the first ADB 52a over a downstream network segment 54b may be the smart monitors 32. In some implementations, there may be an additional seat electronic box (SEB) 56 that handles some data processing operations shared amongst multiple smart monitors 32. The further downstream network segments 54c may be shared with the peripheral devices connected to the smart monitor such as a credit card reader on the remote controller 28, a USB port, and the like.

A second ADB 52b is also directly connected to the network controller/data communications module 48, and is also part of the same network segment 54a. The second ADB 52b is understood to be dedicated for the second set of rows 16b, with individual connections to each of the smart monitors 32 defining a network segment 54d. Although different network segmentation hierarchies are illustrated, for example, one set of smart monitors 32 for the seats 14 being connected to a SEB 56, which in turn is connected to the ADB 52a, along with a direct connection between the smart monitor 32 to the ADB 52b, a typical aircraft configuration will be consistently structured.

Passengers and cabin crew alike may utilize a portable electronic device (PED) 58 while onboard the aircraft 10. PEDs 58 are understood to refer to smart phones, tablet computers, laptop computers, and other like devices that include a general-purpose data processor that executes pre-programmed instructions to generate various outputs on a display, with inputs controlling the execution of the instructions. Although these devices are most often brought on board the aircraft 10 by the passengers themselves, carriers may also offer them to the passengers for temporary use.

Conventional PEDs 58 are understood to incorporate a WLAN (WiFi) module, so the data communications module 48 of the IFEC system 18 includes a WLAN access point 60 that is connected over a local wireless network interface 48b. The PED 58, via the onboard WLAN network, may connect to the IFEC system 18 to access various services offered thereon such as content downloading/viewing, shopping, and so forth. Typically, a single WLAN access point 60 is insufficient for providing wireless connectivity throughout the cabin, so additional WLAN access points 60a and 60b may be installed at various locations spaced apart from each other. These additional WLAN access points 60a, 60b may be connected to the network controller/data communications module 48 over an Ethernet link that is part of the aforementioned local area network 46. The local area network interface or data communications module 48 is understood to encompass the hardware components such as the WLAN transceiver, antennas, and related circuitry, the Ethernet router/switch, as well as the software drivers that interface the hardware components to the other software modules of the IFEC system 18.

Due to the speed/bandwidth limitations associated with current implementations of WiFi and other wireless data networking modalities, the communications between each of the smart monitors 32 and the IFEC server 22, content server 40, and other servers is understood to be over the wired local area network 46. However, it will be appreciated that this is by way of example only and not of limitation. Future wireless networking modalities may bring substantial improvements in transfer speed and available bandwidth such that all of the smart monitors 32 are connected wirelessly, and so the smart monitor 32 are depicted as implementing many different types of networking modalities, including the WiFi module 50b, the Bluetooth module 50c, and so forth. Indeed, this would be desirable because in the weight-restricted context of aircraft installations, the elimination of cables and associated switch/router interfaces would improve aircraft operational efficiency. In this regard, the alternative WiFi data communications module 48b is being presented to illustrate the possibility of utilizing other data networking modalities beyond the wired local area network 46.

The foregoing arrangement of the IFEC system 18, along with its constituent components, have been presented by way of example only and not of limitation. Other aircraft 10 may have any number of different configurations, and may incorporated components that were not mentioned above, or functions may be handled by a different subpart or component than that to which above description attributes. Along these lines, features described above may be omitted from such different configurations.

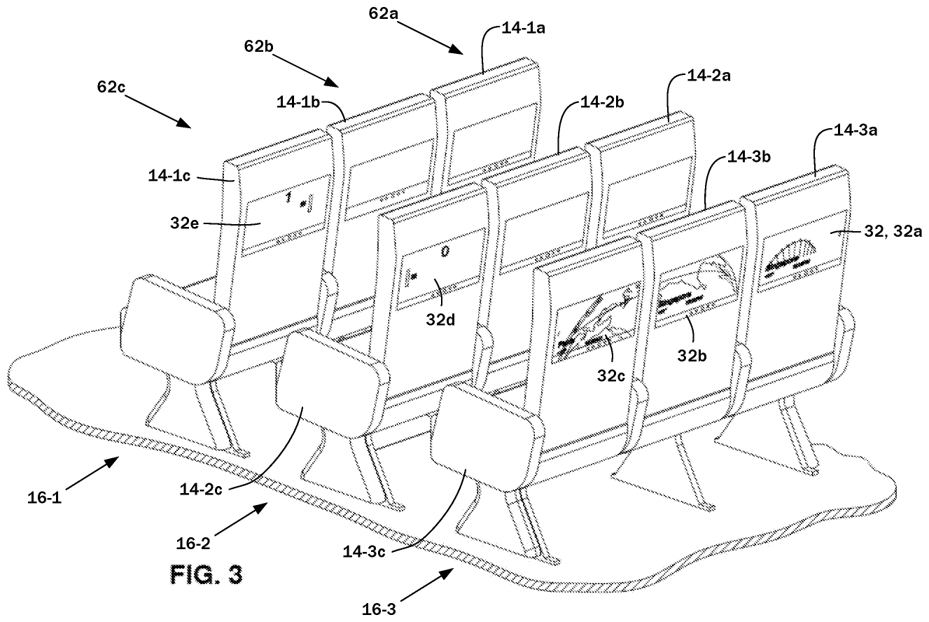

FIG. 3 illustrates additional details of a typical seating configuration in the aircraft 10 or other vehicle, and the seatback installation of the smart monitors 32. In the excerpted example, there are three rows of seats with a further three seats per row: a first row 16-1 including a first row window seat 14-1a, a first row middle seat 14-1b, and a first row aisle seat 14-1c; a second row 16-2 including a second row window seat 14-2a, a second row middle seat 14-2b, and a second row aisle seat 14-2c; and a third row 16-3 including a third row window seat 14-3a, a third row middle seat 14-3b, and a third row aisle seat 14-3c The window-side or the internal aisle-side of the fuselage 12 is not depicted in FIG. 3, so the reference to aisle, middle, and window seats is for identification purposes only. A given column/aisle of seats may be identified according to aisle, middle, and window in the illustrated example. For instance, the first row window seat 14-1a, the second row window seat 14-2a, and the third row window seat 14-3a may be collectively referred to as a window column 62a. Furthermore, the first row middle seat 14-1b, the second row middle seat 14-2b, and the third row middle seat 14-3b may be collectively referred to as a middle column 62b Likewise, the first row aisle seat 14-1c, the second row aisle seat 14-2c, and the third row aisle seat 14-3c may be collectively referred to as an aisle column 62c. The three seat per row configuration shown in FIG. 3 is by way of example only and not of limitation. The present disclosure may be implemented in seating arrangements with two seats per row, four seats per row, five seats per row, or any other configuration.

As shown, each of the seats 14 have a seatback display or smart monitor 32 mounted thereto. The present disclosure contemplates various ways in which images, animations, and other multimedia content are displayed over multiple smart monitors 32 in a given row 16, or a given column 62, with each communicating among each other. That is, in the example illustrated, the row 16-3 of seats may include a first smart monitor 32a for the window seat 14-3a, a second smart monitor 32b for the middle seat 14-3b, and a third smart monitor 32c for the aisle seat 14-3c. A single graphic, though with multiple segments, is contemplated to be displayed across the three smart monitors 32a, 32b, and 32c in accordance with one embodiment of the disclosure, with certain foreground elements moving from one smart monitor to another. According to another embodiment, a single graphic may be displayed across the smart monitors of a single column 62, for example, on the smart monitor 32d of the second row aisle seat 14-2c and the smart monitor 32e of the first row aisle seat 14-1c. Thus, shared viewing experiences between adjacently or proximally seated passengers are possible. Additional exemplary displays will be described below.

Also referring again to the block diagram of FIG. 2, each of the first, second and third smart monitors 32a, 32b, and 32c are understood to be identical with the same hardware components and software applications loaded thereon. Accordingly, those features that were described above in the context of the first smart monitor 32, e.g., the data processor 34, the graphics subsystem 36, the network interface controller 50, etc. are understood to be applicable to the second smart monitor 32b installed on the third row middle seat 14-3b and the third smart monitor 32c installed on the third row aisle seat 14-3c. Thus, such details will be omitted for the sake of brevity.

The first smart monitor 32a, the second smart monitor 32b, and the third smart monitor 32c are connected to the data communications module 48, which routes data traffic between each of the nodes of the smart monitors 32a-32c. Alternatively, in some embodiments, direct, point-to-point data communications links may be established between each of the smart monitors 32a-32c, but this is optional. As indicated above, the data communications module 48 is the gateway to the IFEC server 22/head end, from which multimedia content and other data may be retrieved. The example setup shown in the block diagram of FIG. 2 is intended only as an corresponding detailed depiction of the three smart monitors 32 installed on the seatbacks of the third row 16-3 shown in FIG. 3. Other smart monitors installed on other seats 14 are also connected to the data communications module 48, and it is possible for any one smart monitor 32 to communication with any other smart monitor 32 that is a node on the local area network 46 of the aircraft 10.

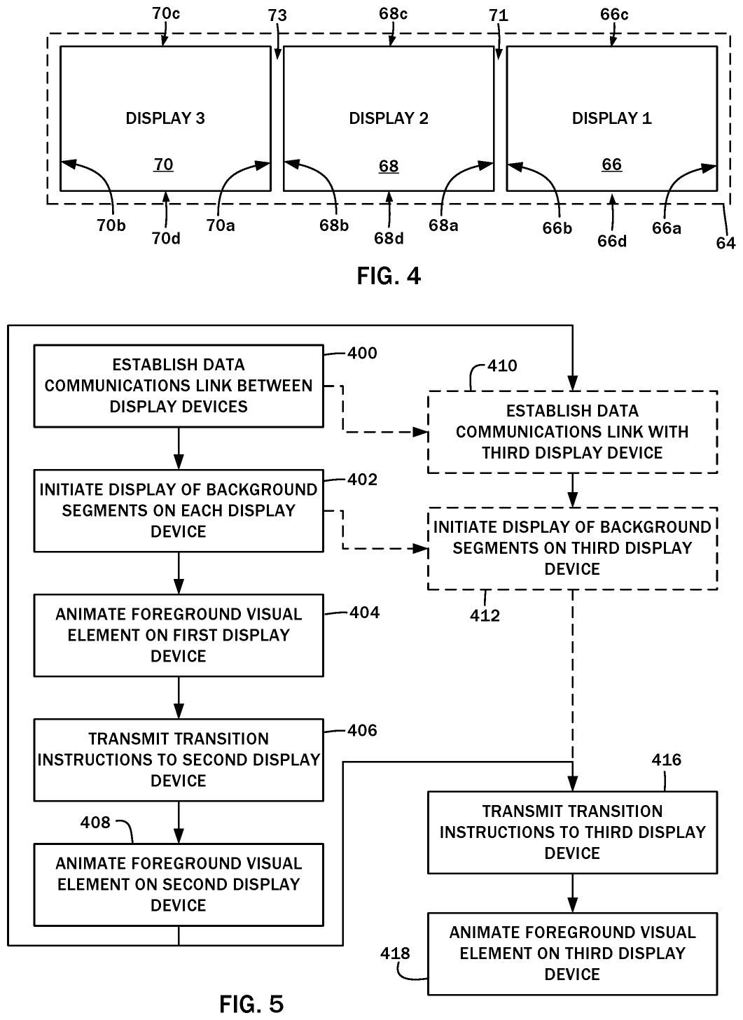

FIG. 4 illustrates an example composite display area 64 that is defined when the three smart monitors 32a-32c of one row 16 are combined. There is a first segment 66 that corresponds to the display of the rightmost first smart monitor 32a, a second segment 68 that corresponds to the display of the middle second smart monitor 32b, and a third segment 70 that corresponds to the display of the leftmost third smart monitor 32c, when arranged and installed on the seats 14-3a, 14-3b, and 14-3c, respectively.

The first segment 66 is defined by a first display proximal end 66a and a first display distal end 66b opposite thereto. When arranged as shown, the second segment 68 is defined by a second display proximal end 68a that is adjacent to the first display distal end 66b, with first lateral gap 71 defined between the two. Opposite the second display proximal end 68a is a second display distal end 68b. Additionally, the third segment 70 is defined by a third display proximal end 70a that is adjacent to the second display distal end 68b with a second lateral gap 73 defined between the two. Opposite the third display proximal end 70a is a third display distal end 70b. The first display proximal end 66a corresponds to the rightmost end of the composite display area 64, while the third display distal end 70b corresponds to the leftmost end of the composite display area 64. Each of the segments 66, 68, and 70 are defined by respective top ends 66c, 68c, and 70d, as well as opposite bottom ends 66d, 68d, and 70d.

An underlying image or multimedia content may be rendered within composite display area 64, but in accordance with various embodiments of the present disclosure, separated into the first segment 66, the second segment 68, and the third segment 70. There may also be a moving element that is successively rendered on one or more of the segments 66, 68, and 70, where upon reaching one end of one segment, the same element begins to be displayed on the end of the next segment adjacent thereto.

One embodiment in particular is directed to a method for presenting content on multiple display devices of the IFEC system 18. The flowchart of FIG. 5 illustrates the steps of this method, which is understood to begin with a step 400 of establishing a data communications link between a first one of the multiple display devices, e.g., the first smart monitor 32a, and a second one of the multiple display devices, e.g., the second smart monitor 32b. This is the portion of the composite display area 64 that corresponds to the first segment 66. While one embodiment of the method is described in terms of a first display and a second display, the steps are applicable to a third display, and so there may be an additional, though optional step 410 of establishing the data communications link with the third one of the multiple display devices, e.g., the third smart monitor 32c.

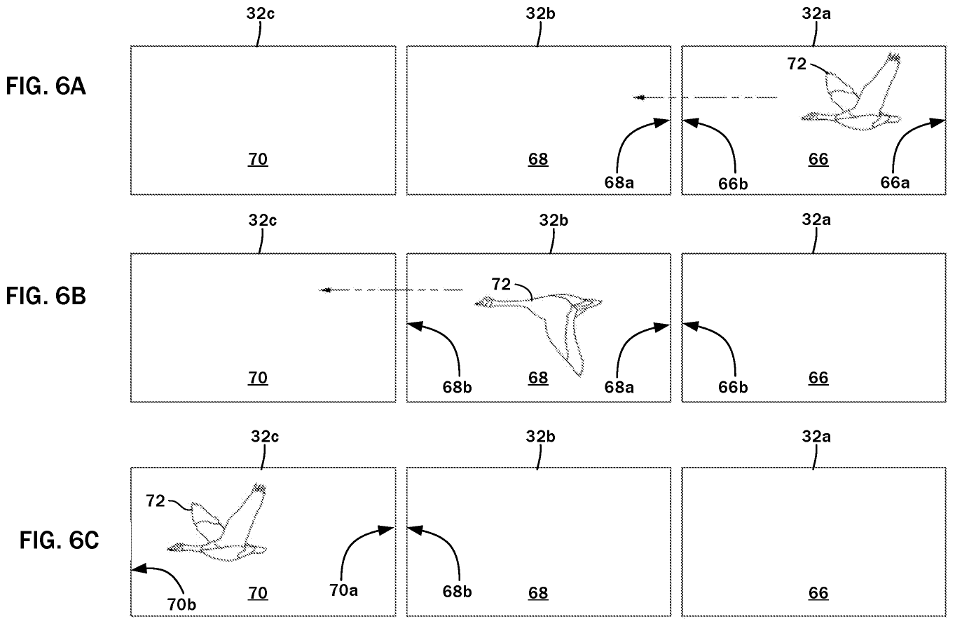

The method continues with initiating a display of a first background segment of the content on the first smart monitor 32a, as well as a display of a second background segment of the content on the second smart monitor 32b. These take place in accordance with a step 402. To the extent there is a third smart monitor 32c involved, there is an additional step 412 of displaying a third background segment on the third smart monitor 32c. FIGS. 6A-6C illustrate an exemplary animation sequence that may be presented on a row of three smart monitors 32a, 32b, and 32c. Although the background appears blank in the illustration, a solid color background is nevertheless understood to be a background segment, and each of the smart monitors 32a, 32b, and 32c thus displays the respective first segment 66, the second segment 68, and the third segment 70.

An embodiment of the method includes a step 404 of animating one or more foreground visual elements on the first smart monitor 32a. Referring again to the example of FIGS. 6A-6C, the foreground visual element 72 is a flying bird that has a trajectory moving from the first display proximal end 66a toward the first display distal end 66b. As the bird flies toward the left end of the screen and eventually off the first segment 66, those parts reaching the first display distal end 66b are successively removed from view on the first smart monitor 32a.

The method continues with a step 406 of transmitting transition instructions to the second smart monitor 32b indicating that those successive portions removed from the first segment 66 are now ready to be displayed on the second smart monitor 32b and continue the animation effect/movement. As demonstrated in FIG. 6B, upon receipt of these transition instructions, the second smart monitor 32b begins rendering the animation of the bird, that is, the foreground visual element 72. Generally, there is a method step 408 of animating corresponding sections of the foreground visual element 72 being animated off of the first smart monitor 32a, on the second smart monitor 32b. Continuing with the right-to-left trajectory that began in the first smart monitor 32a, the bird moves in a similar right-to-left trajectory on the second smart monitor 32b, that is, from the second display proximal end 68a to the second display distal end 68b.

To the extent the third smart monitor 32c is being used, the animation effect may be continued thereon with the same steps. As shown in the flowchart of FIG. 5, there is a step 416 of transmitting transition instructions to the third smart monitor 32c. Those successively removed parts of the foreground visual element 72 from the second smart monitor 32b are thereafter rendered/animated on the third smart monitor 32c according to a step 418. The steps 416 and 418 are understood to be equivalent to those of steps 406 and 408 executed in relation to the first smart monitor 32a and the second smart monitor 32b, but in relation to the second smart monitor 32b and the third smart monitor 32c, respectively. On the third smart monitor 32c, the bird/foreground visual element 72 moves along the same right-to-left trajectory from the third display proximal end 70a to the third display distal end 70b.

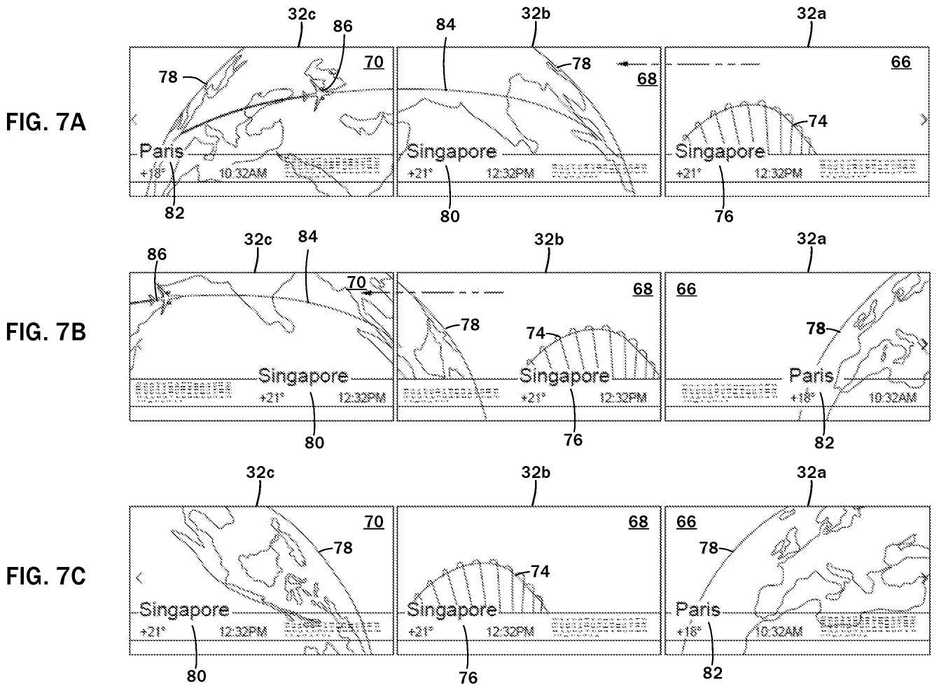

More sophisticated animation effects are contemplated, though involving the same fundamental steps as described above in connection with the example shown in FIGS. 6A-6C. With reference to FIGS. 7A-7C, multiple smart monitors 32a-32b can be utilized to animate a plurality of foreground visual elements 72. Generally, the illustrated example is a destination/origin flight tracking screen on a flight between the cities of Paris and Singapore.

In the first part of the animation sequence shown in FIG. 7A, the first segment 66 includes a photograph 74 of the Singapore skyline showing the Gardens by the Bay Cloud Forest structure. There is additionally a text overlay 76 with the destination city header indicating “Singapore” along with the local temperature and local time. The second segment 68 includes a first half of a partial globe 78 that spans the origin/destination cities, with another text overlay 80 with the same destination city header. The third segment 70 includes the second half of the partial globe 78 with a text overlay 82 with the origin city header indicating “Paris” along with the local temperature and local time thereof. Additionally, there is a flight path tracker 84 extending between the representations of the origin and destination cities, along with an icon 86 of the aircraft 10 positioned at the current location.

In this animation sequence, each of the foregoing components is understood to be a foreground visual element, as they each move from one smart monitor 32 to the next in the proscribed display. Underneath there may be static graphics that do not move, or there may be a solid color or color gradient that remains consistent throughout the animation sequence.

In the next part of the animation sequence shown in FIG. 7B, the foreground visual elements 72 originally presented in the first segment 66 has shifted to the second segment 68. For example, the photograph 74 is now in the second segment 68, with a reduced portion of the partial globe 78. The text overlay 76 has shifted toward the left, though positioned at the same location relative to the underlying photograph 74. The second half of the globe 78, together with the text overlay 80 has been shifted to the third segment 70, and the view of the globe 78 has been rotated. Meanwhile, the portion of the globe 78 showing the origin city, Paris, has been shifted from the third segment 70 back to the first segment 66, which now includes the text overlay 82 with the origin city identified along with the local temperature and local time thereof.

The animation sequence concludes with the display arrangement shown in FIG. 7C, with the part of the globe 78 corresponding to the destination city, Singapore, filling the third segment 70, the part of the globe 78 corresponding to the origin city, Paris, filling the first segment 66, with the photograph 74 positioned within the second segment 68. The text overlays 76, 80, and 82 follow the corresponding portions of the globe 78 and the photograph 74. Thus, the presentation “carousels” the image of the globe centered on the destination city, the image of the globe centered on the origin city, and the representative photograph of the destination city from one smart monitor 32 to the next. This sequence may be displayed during, for example, boarding, disembarking, and mid-flight.

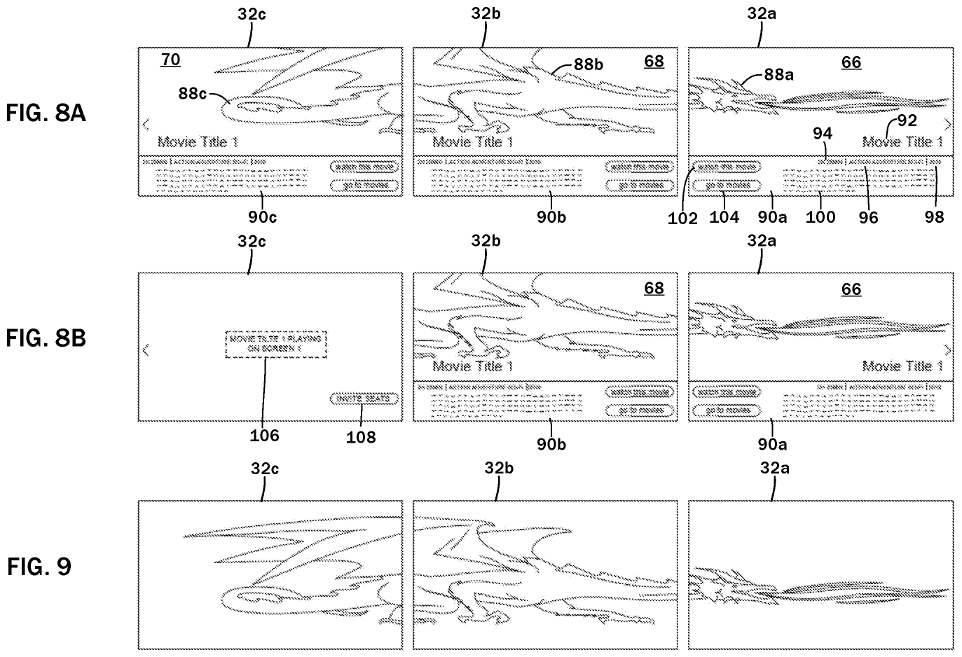

FIGS. 8A and 8B illustrate another exemplary display sequence over multiple smart monitors 32 that represents another embodiment of the present disclosure. As shown, there is a single background image 88, e.g., of a fire-breathing dragon that is displayed across the first segment 66, the second segment 68, and the third segment 70. The background image 88 is separated into each segment corresponding to the smart monitors 32a-32c, e.g., a first background image segment 88a shown in the first smart monitor 32a, a second background image segment 88b shown in the second smart monitor 32b, and a third background image segment 88c shown in the third smart monitor 33c. Both static and looping animations may be utilized for the background image 88. This background image 88 is not understood to move from one segment to the other.

Each of the smart monitors 32a-32c, however, overlays its own content selection interface 90, specifically a first content selection interface 90a, a second content selection interface 90b, and a third content selection interface 90c, respectively, on top of the background image 88. Each of the content selection interfaces 90 includes a title 92, a content duration 94, and a content category 96, a content release year 98, and a description 100. Furthermore, each content selection interface 90 includes an play button 102 and a menu return button 104. The presentation of the content selection interfaces 90 is contemplated to allow each individual passenger seated immediately in front of the respective smart monitors 32a-32c to separately interact therewith and begin viewing the content as desired.

FIG. 8B illustrates an example in which the passenger using the third smart monitor 32c selects the play button 102 (labeled as “watch this movie”). Within the third smart monitor 32c, playback of the content begins in a playback window 106 independently of anything else displayed in the first smart monitor 32a and the second smart monitor 32b. Within the playback window 106 an invite button 108 may be presented, which invites other viewers in the same row 16 to view the same content. If the other passengers accept, the view of the content may be expanded across the multiple smart monitors 32, e.g., extended to the first smart monitor 32a and the second smart monitor 32b, as shown in FIG. 9.

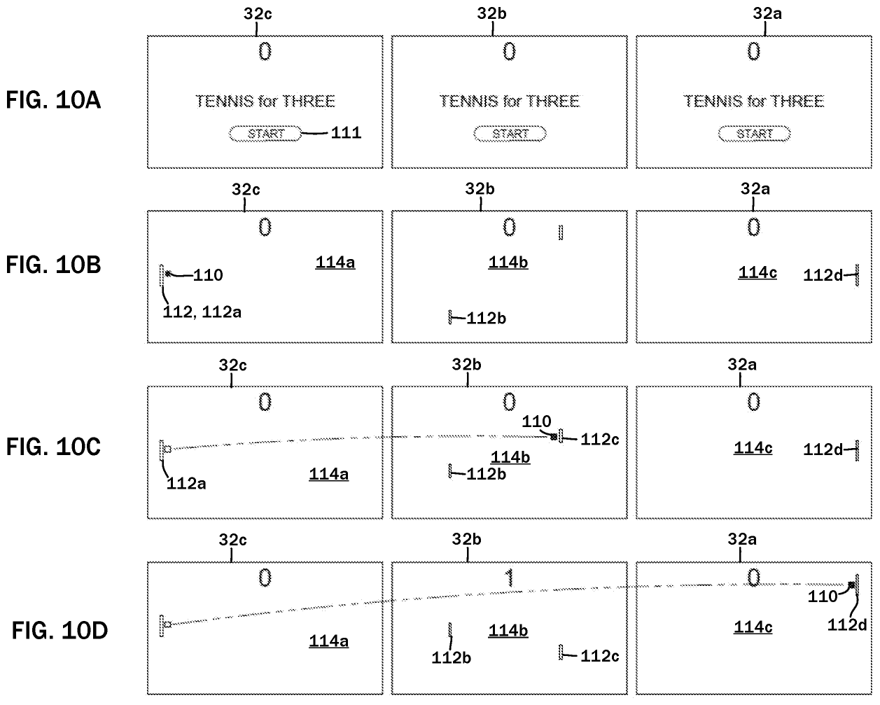

The method for presenting content on multiple display devices is not limited to the presentation of static images or pre-made animation or moving graphics. As shown in the example of FIGS. 10A-10D, interactive applications may be presented across the smart monitors 32, with the foreground visual element moving between all three. One exemplary interactive application is a tennis game in which a “ball” graphic element 110 bounces back upon striking a paddle graphic element 112 that is strategically moved by each of the players. FIG. 10A depicts an introductory screen that is displayed on each of the smart monitors 32a-32c that includes a start button 111 that is selectable by the user to begin the game. This input may be provided via the aforementioned remote controller 28, or any other available input modality. FIG. 10B depicts the beginning of the game after the ball 110 moves away from a first paddle 112a located within a first screen segment 114a displayed in the third smart monitor 32c. Moreover, a second screen segment 114b is displayed in the second smart monitor 32b, and includes a second paddle 112b and a third paddle 112c. Lastly, a third screen segment 114c is displayed in the third smart monitor 32c, with a fourth paddle 112d.

As shown in FIG. 10C, the ball 110 moves away from the first screen segment 114a and into the second screen segment 114b, hitting the third paddle 112c. The paddles 112 are moved into position via user input, and so the method may include receiving such input. A visual effect, e.g., the paddle 112 moving vertically from the top to the bottom, may be generated in response to the input. The game application may be programmed to return the ball 110 at a different angle or speed depending on the specific location on the third paddle 112c at which the ball 110 was struck. Thus, the general trajectory of the foreground visual element or the ball 110 may be altered based upon the user input. If the player assigned to the first screen segment 114a is unable to return the ball 110, then a point is added for the player assigned to the second screen segment 114b.

The movement of the ball 110 is not limited to between the first screen segment 114a and the second screen segment 114b. As shown in FIG. 10D, the ball 110 may be hit across the second screen segment 114b and to the third screen segment 114c if neither the second paddle 112b nor the third paddle 112c interferes with its trajectory.

While each of the foregoing examples of the type of content that may be presented across multiple display devices involved rows of smart monitors 32 located side-by-side, it is expressly contemplated for the method to be implemented over multiple rows, or along a single column of seats 14. Referring again to the seating arrangement shown in FIG. 3, the fourth smart monitor 32d installed on the second row aisle seat 14-2c and the fifth smart monitor 32e installed on the first row aisle seat 14-1c are interconnected in accordance with embodiments of this disclosure, with the tennis game interface being presented thereon. Beyond the aircraft-installed smart monitors 32, it is also contemplated that the display may be extended to PEDs 58 that are connected to the local area network 46 of the aircraft 10.

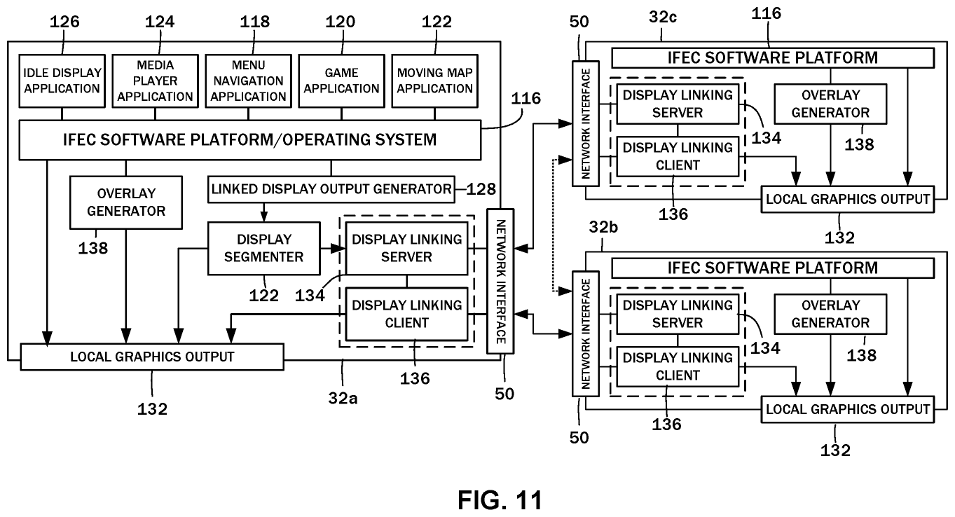

The block diagram of FIG. 11 depicts one embodiment of the components of the smart monitors 32 that may implement the presentation of content across multiple displays. One of the smart monitors, that is, a first smart monitor 32a may be designated as a primary that directs the others to display the content in accordance with the instructions it provides. In further detail, the smart monitors 32 each include an operating system or IFEC software platform 116 that is executed by the data processor 34. As will be recognized by those having ordinary skill in the art, the IFEC software platform 116 provides a set of basic functions that various applications may utilize to implement certain functionality. There may be a menu navigation application 118, a game application 120, a moving map application 122, a media player application, as well as an idle display application 124. Although described as separate applications, these may be implemented in a single application with respective sub-parts. Regardless of the functionality, the applications are understood to generate outputs that may be displayed across multiple smart monitors 32 in accordance with various embodiments of the present disclosure.

The display outputs are passed from the IFEC software platform 116 to a linked display output generator 128 that is implemented as a series of instructions that are executed by the data processor 34. The linked display output generator 128 receives the display data and expands the same to encompass the composite display area 64 for the multiple displays. That is, a composite output display screen that includes the aforementioned background visual content elements and one or more foreground visual content elements are rendered.

The composite output display screen is separated into sections specific to the respective smart monitors 32 by a display segmenter 130. At least one part of the composite output display screen is displayed by the first smart monitor 32a, so the designated local display screen segment is passed to a local graphics output 132. This is understood to correspond to the graphics subsystem 36 and the display 24 described above. The other display screen segments are for the other smart monitors 32b and 32c. In this regard, the first smart monitor 32 includes a display linking server 134 that is implemented as a series of instructions executed by the data processor 34. The display linking server 134 transmits the display screen segments to corresponding display linking clients 136 running on the other smart monitors once client-server communications links have been established therewith.

The second smart monitor 32b and the third smart monitor 32c each execute respective instances of the display linking client 136, which communicates with the display linking server 134 to retrieve the secondary display screen segments. This data is then passed to the respective local graphics outputs 132 of the second smart monitor 32b and the third smart monitor 32c. Whether on the first smart monitor 32a or on the second or third smart monitors 32b, 32c, outputs particular thereto may be generated. One example is the content selection interface 90 that is overlaid on the background image 88 separately for each of the smart monitors 32. These graphical outputs are generated by the IFEC software platform 116 and passed to an overlay generator 138 that coordinate the display of such overlays with the underlying graphics output from the display segmenter 130. Where an overlay is not needed the IFEC software platform 116 may directly pass the display data to the local graphics output 132.

The particulars shown herein are by way of example and for purposes of illustrative discussion of the various embodiments of the system for presenting content across multiple display devices of an in-flight entertainment system only and are presented in the cause of providing of what is believed to be the most useful and readily understood description of the principles and conceptual aspects thereof. In this regard, no attempt is made to show more details than are necessary for a fundamental understanding of the disclosure, the description taken with the drawings making apparent to those skilled in the art how the several forms of the presently disclosed system may be embodied in practice.

1-7. (canceled)

8. A method for presenting content on multiple display devices of an in-flight entertainment system, the method comprising:
establishing a data communications link between a first one of the multiple display devices and a second one of the multiple display devices, the first one of the multiple display devices being defined by a first display proximal end and an opposite first display distal end, and the second one of the multiple display devices being defined by a second display proximal end adjacent to the first display distal end and an opposite second display distal end;
segmenting background content of the content into a first background segment and a second background segment, each corresponding to the first one of the multiple display devices and the second one of the multiple display devices, respectively;
initiating a display of the first background segment of the content on the first one of the multiple display devices and a display of the second background segment of the content on the second one of the multiple display devices;
animating one or more foreground visual elements of the content on the first one of the multiple display devices, the one or more foreground visual elements having general trajectories along a direction of the first display proximal end toward the first display distal end, successive sections of individual ones of the one or more visual elements being removed from the first one of the multiple display devices as each of the sections move toward and reach the first display distal end;
transmitting transition instructions to the second one of the multiple devices from the first one of the multiple display devices upon successive sections of the individual ones of the one or more foreground visual elements reach the first display distal end; and
animating on the second one of the multiple display devices, corresponding sections of the one or more foreground visual elements being animated off of the first one of the multiple display devices in response to the transition instructions, the one or more foreground visual elements having general trajectories along a direction of the second display proximal end toward the second display distal end.

9. The method of claim 8, further comprising:
receiving a first input for the first one of the multiple display devices; and generating a visual effect on the first one of the multiple display devices in response to the first input.

10. The method of claim 9, wherein the first input modifies at least one of the general trajectories of the one or more foreground visual elements as displayed on either or both of the first one of the multiple display devices and the second one of the multiple display devices.

11. The method of claim 8, further comprising:
establishing a data communications link to a third one of the multiple display devices from either or both of the first one of the multiple display devices and the second one of the multiple display devices, the third one of the multiple display devices being defined by a third display distal end and an opposite third display proximal end adjacent to the second display distal end;
initiating a display of a third background segment of the content on the third one of the multiple display devices.

12. The method of claim 11, further comprising:
animating one or more foreground visual elements on the second one of the multiple display devices, the one or more foreground visual elements having general trajectories along a direction of the second display proximal end toward the opposite second display distal end, successive sections of individual ones of the one or more visual elements being removed from the second one of the multiple display devices as each of the sections move toward and reach the second display distal end;
transmitting another set of transition instructions to the third one of the multiple devices from the second one of the multiple display devices upon successive sections of the individual ones of the one or more foreground visual elements reach the second display distal end; and
animating, on the third one of the multiple display devices, corresponding sections of the one or more foreground visual elements being animated off of the second one of the multiple display devices in response to the other set of transition instructions, the one or more foreground visual elements having general trajectories along a direction of the third display proximal end toward the third display distal end.

13. The method of claim 8, wherein the first one of the multiple display devices and the second one of the multiple display devices are installed on adjacent passenger seats across a single row.

14. The method of claim 8, wherein the first one of the multiple display devices and the second one of the multiple display devices are installed on adjacent passenger seats over multiple rows along a single aisle.

15. The method of claim 8, further comprising displaying a graphical interface overlay specific to the first one of the multiple display devices independent of the second one of the multiple display devices.

16. The method of claim 15, further comprising displaying another graphical interface overlay specific to the second one of the multiple display devices independent of the first one of the multiple display devices.

17. A method for expanding the display of graphical content over multiple spatially separated smart monitors of an in-flight entertainment system, the method comprising:
initiating data communications links between each of the multiple smart monitors; segmenting a background graphical content of the graphical content into corresponding sections for each
of the multiple smart monitors, each of the sections being unique to a specific one of the smart monitors;
displaying each of the sections of the background graphical content on respective ones of the smart monitors;
animating a moving foreground graphical content of the graphical content across one or more of the smart monitors, transitions of the moving foreground graphical content from an originating one of the smart monitors to a destination one of the smart monitors being communicated over the corresponding data communications link initiated therewith; and
receiving inputs from the smart monitors, the inputs correspondingly modifying the animating of the moving foreground graphical content.

18. The method of claim 17, wherein the smart monitors are installed on adjacent passenger seats across a single row.

19. The method of claim 17, wherein the smart monitors are installed on adjacent passenger seats over multiple rows along a single aisle.

20. The method of claim 17, further comprising displaying an interactive graphical user interface overlay on one of the smart monitors with the respective section of the background graphical content being continuingly displayed.
